(19) United States
(12) Patent Application Publication
(10) Pub. No.: US 2026/0301418 A1
(43) Pub. Date: Oct. 1, 2026

(54) Dynamic Object Detection Using Connected Vehicles

(71) Applicant: Nissan North America, Inc., Franklin, TN (US)

(72) Inventors: Mark Bailey, Seattle, WA (US); Luis Lorenzo Bill Clark, San Francisco, CA (US); Stefan Witwicki, San Carlos, CA (US); Erik Lee St. Gray, Tacoma, WA (US)

(21) Appl. No.: 19/094,259

(22) Filed: Mar. 28, 2025

(51) Int. Cl. G06V 20/58

(52) U.S. Cl. CPC G06V 20/58

(57) ABSTRACT

System and method for detecting objects outside of a vehicle using object-detection data that is shared between vehicles engaged in searching for the same object. A small language model performs query understanding and object-label extraction and a large-language model, in conjunction with an object detector, detects the object from image data captured by cameras or other sensors of the vehicle. Object-detection data is sent to a remote server or to other vehicles, which respond with their own object-detection data for the same object. The various object-detection data is integrated and provided to a user, for example, by a graphical display.

### TECHNICAL FIELD

This disclosure relates generally to detecting objects outside of a vehicle based on user prompts, and more specifically, to detecting and/or locating objects using object-detection data that is shared between vehicles engaged in or previously engaged in searching for a same, similar, or related object.

### BACKGROUND

Modern vehicle-based systems are increasingly leveraging advanced technologies to improve driver awareness and safety, often by integrating sensor data such as images, video, and lidar. These systems aim to enhance situational understanding by providing drivers with real-time information about their surroundings. However, there remains a need for more effective ways to search for, identify, and/or locate objects of interest, particularly when the search is dynamic, e.g., the object of interest changes its location. Effective dynamic object searching may benefit from collaboration across multiple vehicles or devices.

Current methods of detecting and recognizing objects within an environment typically rely on single-source image data or localized processing. For instance, object detection systems often use cameras, lidar, or radar to capture environmental data. While effective, these methods do not fully leverage the power of distributed data collection or real-time collaboration across multiple vehicles. Furthermore, many existing systems rely on basic image processing or computer vision techniques that may lack the advanced query understanding needed to interpret user queries in a meaningful and actionable way.

Recent advancements in language models, particularly small language models (SLMs) and large language models (LLMs), have shown great promise in enhancing the capability of such systems. These models are capable of understanding natural language queries and extracting relevant information from complex data. The use of these models in conjunction with object detection systems enables more precise and context-aware searches. However, a gap remains in combining these capabilities across multiple vehicles to provide a more comprehensive and collective search result that improves the accuracy and relevance of detected objects.

### SUMMARY

This disclosure addresses one or more of the shortcomings mentioned above by providing a method for performing real-time, collaborative object detection. This method integrates data from multiple vehicles, utilizing both SLMs and LLMs to interpret user queries, detect objects, and combine results from different sources to generate a more complete search outcome. By transmitting and receiving object-detection data between vehicles and/or remote computing devices, the system enables more accurate identification of objects based on the collective input of multiple vehicles, improving the driver’s situational awareness and enhancing safety.

Specifically, disclosed herein are aspects, features, elements, implementations, and embodiments of a method, a system, and a non-transitory computer-readable medium for dynamic object detection using connected vehicles.

A first aspect of the disclosed implementations is a method that includes the steps of: capturing image data of an environment using an image-capturing device of the first vehicle; receiving a text query from a user of a first vehicle indicating an object of interest; performing, by a small language model (SLM), query understanding and object-label extraction; detecting in the image data, by a large language model (LLM) and an object detector, a first detection of the object of interest based on the object-label extraction; transmitting, to at least one remote computing device, first object-detection data associated with the first detection comprising a first location; receiving, from the at least one remote computing device, second object-detection data associated with at least one second detection of the object of interest contributed by at least one second vehicle comprising at least one second location; integrating the first object-detection data and the second object-detection data to generate a collective search result; and providing, to the user, an indication of the collective search result.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a vehicle for dynamic object detection using connected vehicles.

FIG. 5 is a diagram of an example of a system for implementing dynamic object detection using connected vehicles.

FIG. 6A is a diagram of an example of a system for implementing dynamic object detection using connected vehicles in an environment.

FIG. 6B is a diagram of another example of a system for implementing dynamic object detection using connected vehicles in an environment.

FIG. 7 is a flowchart of an example of a process for dynamic object detection using connected vehicles.

### DETAILED DESCRIPTION

To describe some implementations in greater detail, reference is made to the following figures.

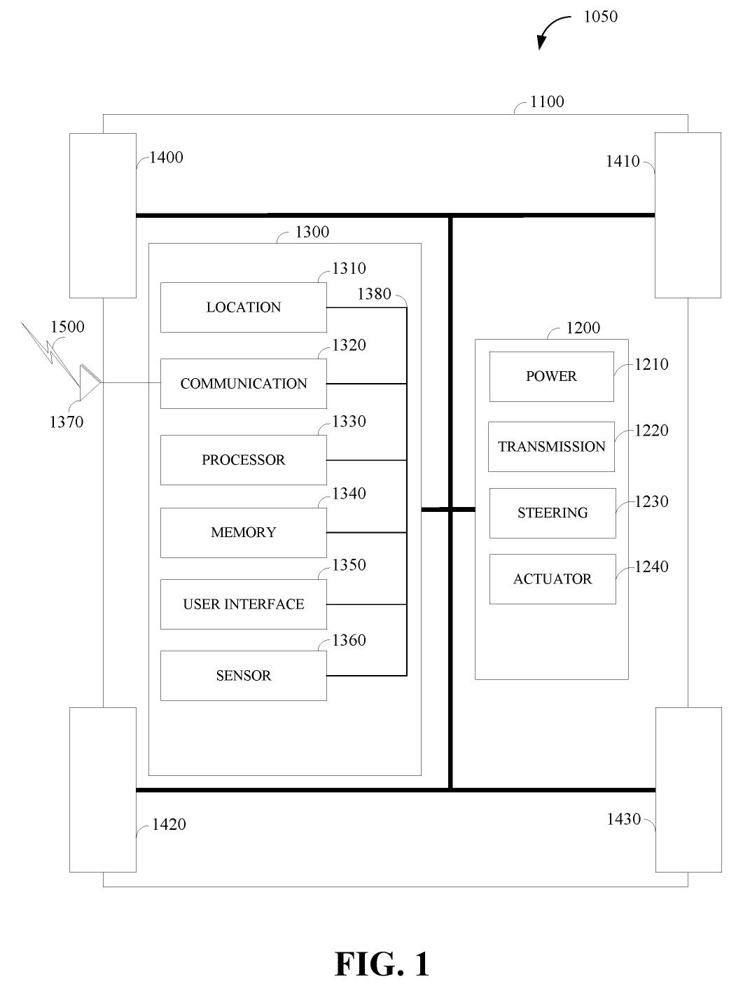

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

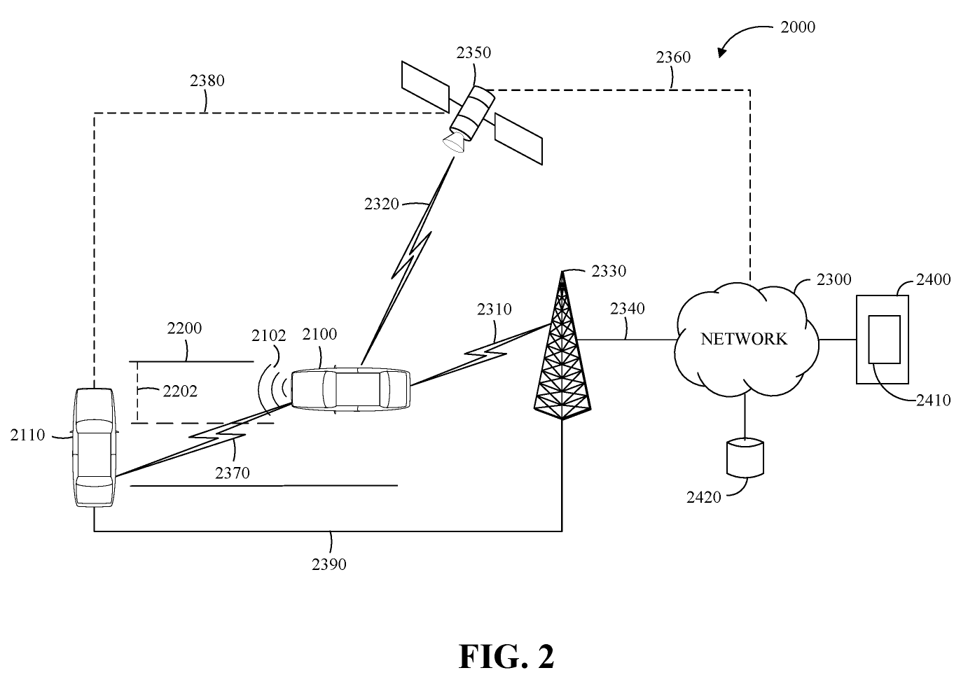

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

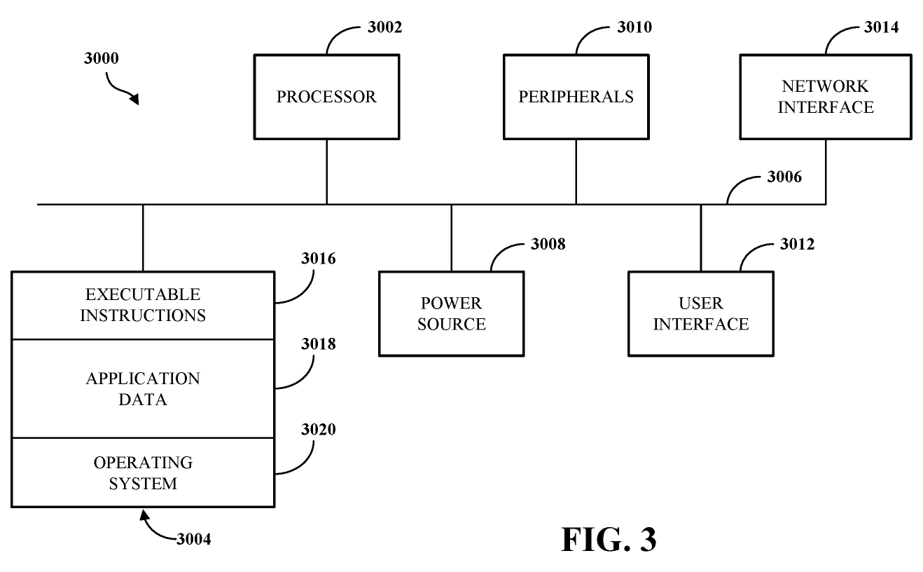

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

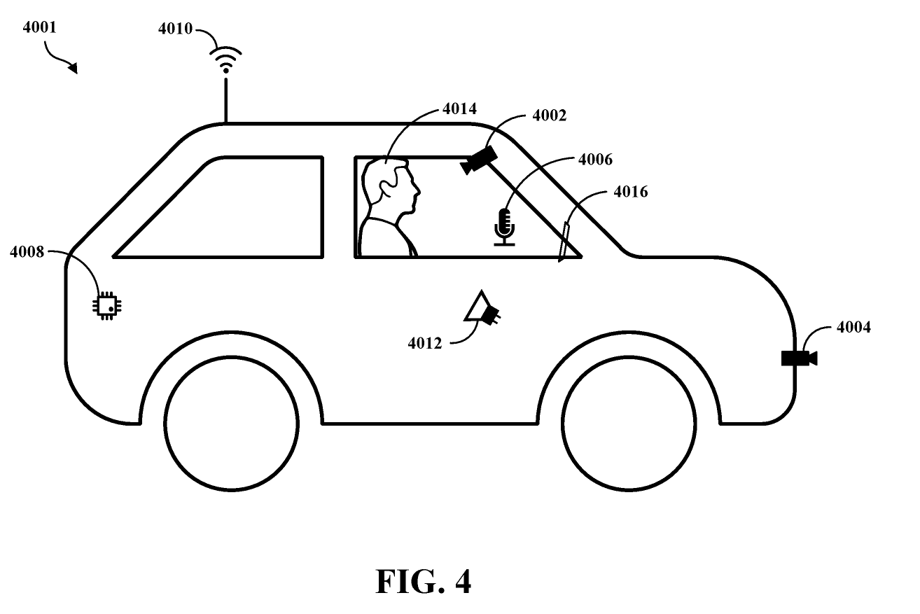

FIG. 4 is a diagram of an example of a vehicle 4001 for dynamic object detection using connected vehicles. The vehicle 4001 may be, for example, the vehicle 1050 of FIG. 1.

The vehicle 4001 includes an external image-capturing device 4004, which may be an instance of the sensor 1360 of FIG. 1, for capturing images of an exterior environment of the vehicle 4001 (and objects and/or events therein). The external image-capturing device 4004 is shown in FIG. 4 as a front-facing device for capturing images ahead of the vehicle, but the external image-capturing device 4004, or a plurality thereof, may face any direction with respect to the vehicle, such as side-, up-, down-, and rear-facing. The images captured by the external image-capturing device 4004 may comprise data of one or more suitable image types, such as optical images, lidar images, infrared images, radar images, or sonar images. Accordingly, the external image-capturing device 4004 may comprise an optical camera (e.g., still camera or video camera), a lidar instrument (e.g., solid state or rotating lidar), an infrared or thermal camera (e.g., still camera or video), a radar device (e.g., continuous-wave or pulse radar), or a sonar instrument (e.g., active or passive sonar).

The vehicle 4001 may include at least one internal image-capturing device 4002, which may be an instance of the sensor 1360 of FIG. 1, for capturing images of an interior environment of the vehicle 4001 (and objects and/or events therein). Specifically, the internal image-capturing device 4002 may capture images of the face of a driver 4014 of the vehicle 4001 (or of a passenger, where the term “user” may be used herein to describe either a driver or a passenger of the vehicle 4001). The internal image-capturing device 4002 may implement or be a part of an eye-tracking system capable of determining a gaze direction or a gaze shift of the driver 4014, for example, straight ahead, to the left, to the right, and so on. In some implementations, the gaze direction of the driver 4014 may be utilized by the system to determine an area of interest that the driver 4014 may be looking toward, which the system can use to adjust a field of view of the external image-capturing device 4004 to more closely align with the area of interest. In some implementations, the gaze direction of the driver 4014 may be utilized by the system to determine an area of interest that the driver 4014 may be looking toward while providing spoken prompts to the system, which the system can use to infer context for the prompt. In some implementations, the gaze shift of the driver 4014 may be interpreted by the system as a response (or a partial response) to a notification to the driver 4014 provided by the system, e.g., a feedback mechanism. While an optical camera may be well suited for capturing images of the face and/or eyes of the driver 4014, the images captured by the internal image-capturing device 4002 may comprise data of one or more suitable image types, such as those described with reference to the external image-capturing device 4004 above.

The vehicle 4001 includes a microphone 4006, which may be an instance of the sensor 1360 of FIG. 1, for detecting spoken prompts from a user, such as queries or commands from the driver 4014 (or from other occupants, not shown in FIG. 4). The terms prompt, query, and command may be used interchangeable herein unless dictated otherwise explicitly or by context. In some implementations, the microphone 4006 may be a directional microphone, such as an array of microphones, for determining an orientation of the head of the driver 4014, for example, if the driver 4014 is looking straight ahead, to the left, to the right, and so on. In some implementations, the orientation of the head of the driver 4014 may be utilized by the system to determine an area of interest that the driver 4014 may be looking toward while providing spoken prompts to the system, which the system can use to infer context for the prompt or to adjust a field of view of the external image-capturing device 4004 to more closely align with the area of interest. In some implementations, the microphone 4006 may implement or be a part of an emotion-recognition system capable of extracting meaning from sentiment or prosody of a spoken prompt or response of the driver 4014. Such meaning may include, for example, positive, negative, or neutral sentiment; excitement, happiness, or anger emotions; agreement or disagreement; or context for the spoken prompt or response.

The vehicle 4001 includes a computing device 4008, which may be an instance of the computing device 3000 of FIG. 3. The computing device 4008 may be configured to execute or partially execute several tasks, such as processing images captured by the external image-capturing device 4004 and/or the internal image-capturing device 4002; processing audio captured by the microphone 4006; executing sentiment analysis or prosody analysis of captured audio; executing an artificial intelligence (AI) model and associated tasks, such as contrastive language-image pretraining (CLIP) tasks that may include generating image embeddings of captured images and text embeddings of spoken (text) prompts; executing integration of various object-detection data; and communicating with additional computing devices, such as cloud-based computing or storage devices, for offloading or partitioning tasks that may be too computationally intensive to be performed locally by the computing device 4008, such as one or more of the tasks listed immediately above. One or more of these tasks are described more fully below. The additional computing devices may be part of a data-processing center, such as the data-processing center 2400 of FIG. 2. The computing device 4008 may utilize a communication interface 4010, such as a wireless antenna, for unidirectional or bidirectional communication to the additional computing devices. The communication interface 4010 may be an instance of the electronic communication interface 1370 of FIG. 3, and the communication may occur via a network, such as the electronic communication network 2300 of FIG. 2.

The vehicle 4001 includes a speaker 4012 (or multiple such speakers), which may be an instance of the user interface 1350 of FIG. 1. The speaker 4012 is configured to provide audible notifications to the driver 4014 regarding objects or events that the system has identified in the exterior environment. The audible notifications may comprise AI-generated spoken language.

The vehicle 4001 includes a graphical display 4016 (or multiple such displays), which may be an instance of the user interface 1350 of FIG. 1. The graphical display 4016 is configured to provide visual notifications to the driver 4014 regarding objects or events that the system has identified in the exterior environment. The visual notifications may comprise AI-generated text, graphics, images, and/or videos.

The audible and visual notifications regarding objects or events are respective example implementations of indications that the system may provide to the driver 4014 regarding the objects or events. Other examples of implementations of indications regarding objects or events, which are not depicted in FIG. 4, include haptic notifications, such as vibrations from an in-seat vibrator; vehicle trajectory notifications, such as an autonomous vehicle altering its trajectory or a navigation system altering its route; vehicle speed notifications, such as a vehicle decelerating; illumination notifications, such as an in-cabin lighting system activating a certain lighting pattern and/or intensity; and so on.

In some implementations, the internal image-capturing device 4002, the external image-capturing device 4004, the speaker 4012, the microphone 4006, and the graphical display 4016 may be components of an in-vehicle infotainment system (IVI).

In some implementations, the internal image-capturing device 4002 and/or the external image-capturing device 4004 may be activated, e.g., begin capturing and/or recording images (e.g., optical images, lidar images, infrared images, radar images, and/or sonar images) in response to a trigger. The trigger may be a suitable event, such as the system detecting a mobile device or key fob entering the cabin environment by a communication channel between the mobile device or the key fob and the vehicle 4001; the system detecting an occupant entering the cabin environment by the internal image-capturing device 4002 or the external image-capturing device 4004 or by an in-cabin proximity sensor; the system detecting an occupant speaking by the microphone 4006; the system detecting the vehicle 4001 waking from a dormant state, for example, via the computing device 4008; or the system detecting the vehicle 4001 departing from an origin by a global navigation satellite system (GNSS). In the case of the system detecting an occupant entering the cabin environment by the internal image-capturing device 4002 or the external image-capturing device 4004, the internal image-capturing device 4002 and/or the external image-capturing device 4004 may be, for example, in a low-power or stand-by state prior to the trigger, where the internal image-capturing device 4002 and/or the external image-capturing device 4004 wake up periodically to capture one or a few images at a low resolution that is sufficient to detect whether an occupant has entered the vehicle 4001. Upon the trigger, the internal image-capturing device 4002 and/or the external image-capturing device 4004 may begin capturing, for example, higher resolution images at a higher frame rate (or sampling rate) than compared to the low-power or stand-by state.

Following the activation of the external image-capturing device 4004 and subsequent capturing of images thereby, the system may begin generating image embeddings of the captured images (or a subset thereof) using a trained AI model, such as a trained CLIP model. An image embedding comprises a high-dimensional vector representation of an image, capturing its essential features and content. An image embedding enables the CLIP model to compare and relate the image to textual descriptions in the same embedding space, i.e., to compare image embeddings to text embeddings, which are described below. This process allows the CLIP model to perform tasks like image classification and retrieval by matching textual descriptions to relevant images. The text embedding also supports zero-shot learning, enabling the model to identify objects or events (or concepts) in images based on textual descriptions without explicit training on those specific tasks. Generating image embeddings and/or comparing image embeddings to text embeddings may be executed by one or more computing devices external to the vehicle 4001, such as a computing apparatus 2410 in the data-processing center 2400 of FIG. 2. In such case, the computing device 4008 of the vehicle 4001 causes the captured images to be transmitted to the one or more external computing devices via the communication interface 4010. Note that CLIP is referenced herein as an exemplary AI model, and various other suitable AI models may be utilized. A treatment of CLIP can be found in the publication: Radford, et al. (2021), Learning Transferable Visual Models From Natural Language Supervision, In Proceedings of the 38th International Conference on Machine Learning (ICML 2021), arXiv:2103.00020.

Also following the activation of the external image-capturing device 4004 and subsequent capturing of images thereby, the system may listen for a spoken prompt from a user of the vehicle 4001 via the microphone 4006. The spoken prompt may be formulated in a suitable manner, such as in complete or incomplete sentences. The system may utilize natural language processing (NLP) to processes voice audio captured by the microphone 4006 into text that may be referred to herein as the text prompt, where the NLP processing may be executed by one or more computing devices external to the vehicle 4001, such as a computing apparatus 2410 in the data-processing center 2400 of FIG. 2. In such case, the computing device 4008 of the vehicle 4001 causes the captured voice audio to be transmitted to the one or more external computing devices via the communication interface 4010.

The system may generate a text embedding of the text prompt using the trained CLIP model. A text embedding comprises a high-dimensional vector representation of a textual description, capturing its essential meaning and context. A text embedding enables the CLIP model to compare and relate the text to image embeddings in the same embedding space, i.e., to compare image embeddings to text embeddings as described above. Generating text embeddings and/or comparing text embeddings to image embeddings may be executed by one or more computing devices external to the vehicle 4001, such as a computing apparatus 2410 in the data-processing center 2400 of FIG. 2. In such case, the computing device 4008 of the vehicle 4001 causes the captured images to be transmitted to the one or more external computing devices via the communication interface 4010.

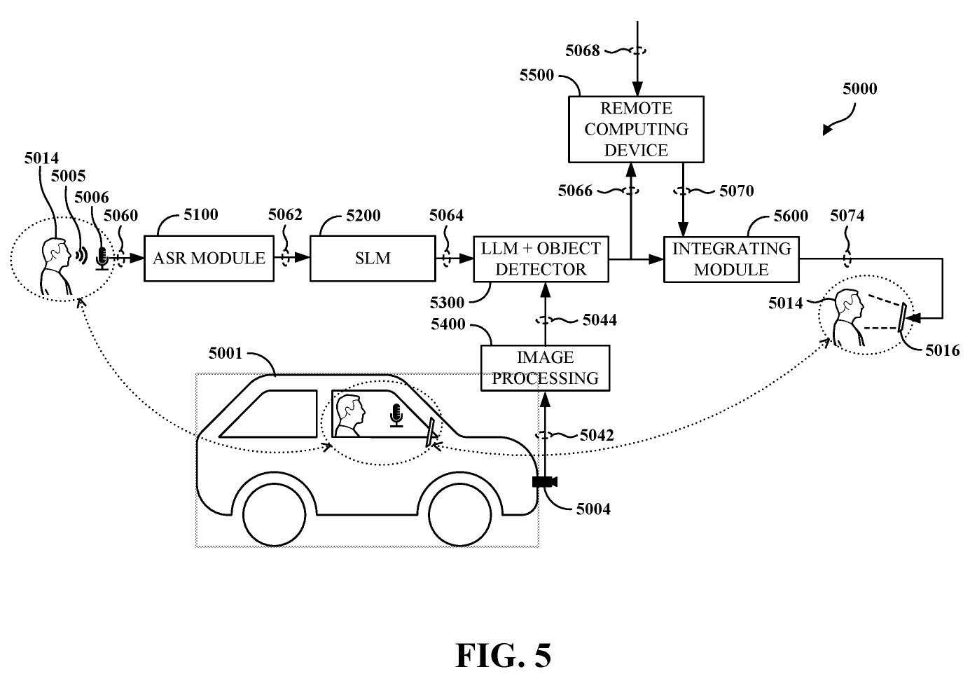

FIG. 5 shows a diagram of an example of a system 5000 for implementing dynamic object detection using connected vehicles. The vehicle 5001, which may be the vehicle 4001 of FIG. 4, comprises an external image-capturing device 5004, a microphone 5006 and a graphical display 5016, which may be the external image-capturing device 4004, the microphone 4006, and the graphical display 4016 of FIG. 4, respectively.

The external image-capturing device 5004 captures images (e.g., still frames, video, 3D scans, etc.) of an environment around the vehicle 5001. The image data 5042, such as raw images, raw video, lidar scans, and so on, is provided to an optional image-processing module 5400, which may be an instance of the computing device 3000 of FIG. 3. The image-processing module 5400 may perform preprocessing to enhance the quality and usability of the image data 5042. This preprocessing may include noise reduction, contrast enhancement, and correction of distortions caused by lens aberrations or environmental conditions. For images and/or video of the image data 5042, the image-processing module 5400 may apply techniques such as edge detection, segmentation, and feature extraction to identify key visual elements. For lidar data of the image data 5042, the image-processing module 5400 may perform point cloud filtering, downsampling, and surface reconstruction to refine the 3D representation of the environment. The processed data may be additionally optimized for further analysis, such as object detection, classification, and tracking, ensuring accurate and efficient identification of objects of interest. The processed image data 5044 is provided to an LLM and object detector 5300 for processing based on a query 5005 (or multiple queries) provided by a driver 5014 and object labels 5064 based thereon.

The driver 5014, which may be the driver 4014 of FIG. 4 (which includes any occupant of the vehicle) may provide the query 5005 orally (e.g., by voice), or by another suitable manner, such as by textual or graphical input. An orally provided query 5005 is captured by the microphone 5006 and converted to electrical signals 5060 for processing by an automatic speech recognition module, referred to herein as the ASR module 5100.

The ASR module 5100 processes the electrical signals 5060 converts the electrical signals 5060 into text, and may, for example, apply speech recognition algorithms to identify phonemes, words, and linguistic structures while accounting for variations in pronunciation, background noise, and speaker differences. The resulting text representation of the query 5005 is then passed to the SLM 5200 for further interpretation and execution of the query 5005.

The SLM 5200 performs query understanding and object-label extraction, which may involve analyzing the linguistic structure and semantic meaning of the query 5005 to identify key terms corresponding to objects of interest. The SLM 5200 extracts relevant object labels, which serve as standardized identifiers that can be used for subsequent object detection processes. These extracted labels enable accurate matching between an intent of the driver 5014 and detected objects in the processed image data 5044 (or in the image data 5042 if the image-processing module 5400 is absent), ensuring precise and efficient search execution. The SLM 5200 outputs structured object labels 5064 derived from the query 5005 to LLM and object detector 5300, which represent objects of interest in a format suitable for downstream processing. The object labels 5064 may include categorical identifiers, synonyms, or descriptors that enhance recognition accuracy.

The LLM and object detector 5300 receives the object labels 5064 from the SLM 5200 and use them to detect instances of the object of interest within the processed image data 5044 (or within the image data 5042 if the image-processing module 5400 is absent). The LLM within the LLM and object detector 5300 enhances object detection by leveraging its advanced contextual understanding and pattern recognition capabilities, enabling it to associate the extracted object labels 5064 with visual features present in the processed image data 5044 or the image data 5042. The processing of the LLM may involve refining detection confidence, resolving ambiguities, or incorporating additional semantic relationships to improve accuracy. The LLM and object detector 5300 determine a first detection of the object of interest and transmit first object-detection data 5066 associated therewith to at least one remote computing device 5500. The first object-detection data 5066 comprises at least a location associated with the object of intertest, which may be derived from a GNSS module, such as an instance of the location unit 1310 of FIG. 1. The first object-detection data 5066 may further comprise a timestamp indicated a time of detection of the object of interest, an image of the object of interest, a video snippet of the object of interest, a CLIP embedding of the object of interest, and other data relevant to the object of interest. In some implementations, CLIP may be utilized by the LLM and object detector 5300 to determine whether the first detection matches the query based on embedding similarity.

In some implementations, the remote computing device 5500 comprises at least one remote server, such as the computing apparatus 2410 and/or the database server 2420 of FIG. 2. The remote computing device 5500 returns second object-detection data 5070 associated with at least one second detection of the object of interest contributed by at least one second vehicle, where the second object-detection data 5070 comprises at least one second location associated with the at least one second detection. In some implementations, the second object-detection data 5070 is retrieved by the remote computing device 5500 from at least one historical database storing prior detections of the object of interest, for example, data 5068 concerning prior detections by multiple second vehicles. In some implementations, the remote computing device 5500 integrates a plurality of prior second detections contributed by a plurality of second vehicles. Integration may include disambiguating similar second detections of the object of interest, eliminating redundant second detections of the object of interest, ranking second detections of the object of interest (for example, based on age or distance from the location of the first detection), and so on.

In some implementations, the remote computing device 5500 comprises one or more computing devices of one or more second vehicles, where each computing device may be an instance of the computing device 3000 of FIG. 3. In response to each second vehicle receiving the first object-detection data 5066, each second vehicle may return its own second object-detection data 5070 associated with its own prior second detection(s) of the object of interest, where the second object-detection data 5070 comprises a second location(s) associated with its prior second detection(s).

In some implementations, a module of the vehicle 5001, such as the LLM and object detector 5300, transmits a search request for the object of interest to the remote computing device 5500 before the vehicle 5001 receives the second object-detection data 5070, effectively instructing second vehicle(s) to search for the object of interest and to report detections thereof back to the vehicle 5001. In some implementations, the search request may be transmitted directly to at least one remote computing device 5500 each comprising a computing device of a second vehicle. In some implementations, the search request may be transmitted to at least one remote computing device 5500 comprising a remote server, which may subsequently instruct one or more second vehicles to initiate a search for the object of interest.

The first object-detection data 5066 and the second object-detection data 5070 are provided to an integrating module 5600, which generates a collective search result 5074 of the object of interest. The integrating module 5600 may disambiguate similar first and second detections of the object of interest, eliminating redundant first and second detections of the object of interest, ranking first and second detections of the object of interest (for example, based on age or distance from the location of the first detection), and so on. For example, the first object-detection data 5066 may comprise a first timestamp, the second object-detection data 5070 may comprise at least one second timestamp, and the integrating module 5600 may rank the first object-detection data 5066 and the second object-detection data 5070 based on recency.

As another example, the integrating module 5600 may prioritize multiple second detection of the object of interest based on current distance from the vehicle 5001. As another example, the collective search result 5074 may include at least one estimated probability that the object of interest is still located at the at least one second location. Such probability may be determined, for example, based on how frequently the object of interest changes locations according to prior first and/or second detections of the object of interest by the first and/or second vehicles.

The collective search result 5074 is provided to the driver 5014 in a suitable format, for example, in visual form by the graphical display 5016 or in audio form by a speaker, such as the speaker 4012 of FIG. 4. In some implementations, the graphical display 5016 may include a graphical user interface (GUI) that shows a map-based indication of at least one of the first location or the at least one second location.

Because the object of interest may not be stationary, i.e., its location may change over time, such as a food truck or a person, it may be advantageous for the system 5000 to update accuracy of prior second detections of the object of interest. In some implementations, the system 5000 captures, in response to the vehicle 5001 arriving near a second location, additional image data 5042 of an additional environment near the second location, and determines whether the object of interest is still located at the second location by attempting to detect the object of interest in the additional image data 5042 by the LLM and the object detector 5300.

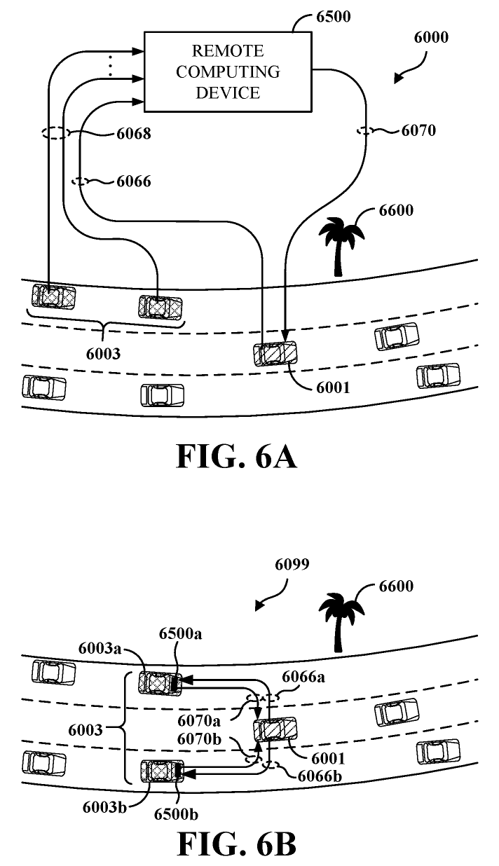

FIG. 6A is a diagram of an example of a system 6000 for implementing dynamic object detection using connected vehicles in an environment. The system 6000 depicts a first vehicle 6001, which may be the vehicle 5001 of FIG. 5, and a plurality of second vehicles 6003. As described above with reference to FIG. 5, an occupant of the first vehicle 6001 may provide a query indicating an object of interest 6600.

The first vehicle 6001 sends first object-detection data 6066, which may be the first object-detection data 5066 of FIG. 5, to a remote computing device 6500, which may be the remote computing device 5500 of FIG. 5. Similarly, the second vehicles 6003 send second object-detection data 6070 related to second detections of the object of interest 6600, which may be comprised in the data 5068 of FIG. 5, to the remote computing device 6500. The remote computing device 6500 sends second object-detection data 6070, which may be second object-detection data 5070 of FIG. 5, to the first vehicle 6001.

The first vehicle 6001 integrates the first object-detection data 6066 and the second object-detection data 6070 to generate a collective search result, such as the collective search result 5074 of FIG. 5, and provides an indication of the collective search result to the occupant of the first vehicle 6001.

FIG. 6B is a diagram of another example of a system 6099 for implementing dynamic object detection using connected vehicles in an environment. The system 6099 depicts a first vehicle 6001, which may be the vehicle 5001 of FIG. 5, and a plurality of second vehicles 6003 including second vehicle 6003a and second vehicle 6003b. As described above with reference to FIG. 5, an occupant of the first vehicle 6001 may provide a query indicating an object of interest 6600.

The first vehicle 6001 sends first object-detection data 6066a, which may be the first object-detection data 5066 of FIG. 5, to a computing device 6500a of the second vehicle 6003a, and the first vehicle 6001 sends first object-detection data 6066b, which may be the first object-detection data 5066 of FIG. 5, and to a computing device 6500b of the second vehicle 6003b, where the computing device 6500a and the computing device 6500b may each be an instance of the computing device 3000 of FIG. 3. The first object-detection data 6066a and the first object-detection data 6066b may comprise identical data. The first vehicle 6001 may optionally send a search query for the object of interest 6600 to the computing device 6500a and the computing device 6500b to initiate searches of the object of interest 6600 by the second vehicle 6003a and the second vehicle 6003b, respectively (e.g., the first vehicle may send the search query before receiving the second object-detection data 6070a and 6070b).

The second vehicle 6003a sends second object-detection data 6070a related to its second detections of the object of interest 6600 to the first vehicle 6001, and the second vehicle 6003b sends second object-detection data 6070b related to its second detections of the object of interest 6600 to the first vehicle 6001.

The first vehicle 6001 integrates the first object-detection data 6066a, the first object-detection data 6066b (which may be the same as the first object-detection data 6066a), the second object-detection data 6070a, and the second object-detection data 6070b to generate a collective search result, such as the collective search result 5074 of FIG. 5, and provides an indication of the collective search result to the occupant of the first vehicle 6001.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 7000 described below is a technique for dynamic object detection using connected vehicles. This technique may be implemented by a system whose components may be internal and/or external to a vehicle, such as the computing device 4008 of FIG. 4, the computing apparatus 241 FIG. 2, or the database server 2420 of FIG. 2.

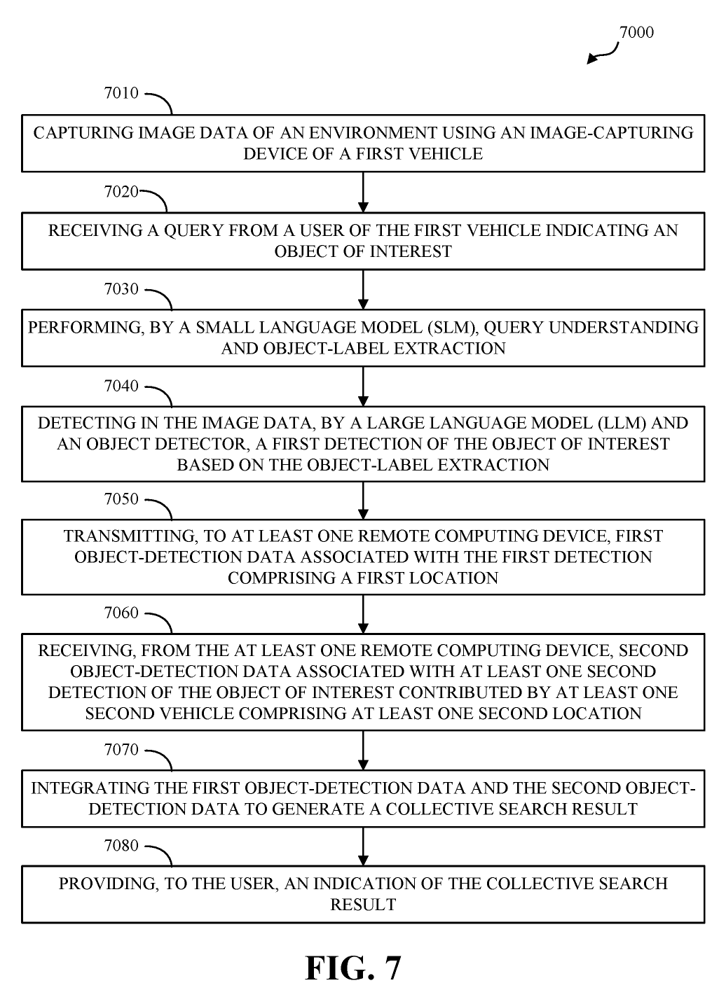

FIG. 7 comprises a flowchart of an example of a process for dynamic object detection using connected vehicles. The step 7010 comprises capturing image data of an environment using an image-capturing device of a first vehicle. The first vehicle may be the vehicle 5001 of FIG. 5; the image-capturing device may comprise the external image-capturing device 5004 of FIG. 5; and the image data may be the image data 5042 of FIG. 5.

In some implementations, the image-capturing device comprises at least one of: an optical device adapted to capture optical images; a lidar device adapted to capture lidar images; an infrared device adapted to capture infrared images; a radar device adapted to capture radar images; or a sonar device adapted to capture sonar images.

The step 7020 comprises receiving a query from a user of the first vehicle indicating an object of interest. The user may be the driver 5014 of FIG. 5; the query may comprise the query 5005 of FIG. 5; and the object of interest may comprise the object of interest 6600 of FIG. 6. In some implementations, the query is received by a voice input captured by a microphone and processed by a ASR module.

The step 7030 comprises performing, by an SLM, query understanding and object-label extraction. The SLM may comprise the SLM 5200 of FIG. 5.

The step 7040 comprises detecting in the image data, by an LLM and an object detector, a first detection of the object of interest based on the object-label extraction. The LLM and object detector may comprise the LLM and object detector 5300 of FIG. 5. In some implementations, the LLM and object detector may determine, by CLIP, whether the first detection matches the query based on embedding similarity.

The step 7050 comprises transmitting, to at least one remote computing device, first object-detection data associated with the first detection comprising a first location. The remote computing device may comprise the remote computing device 5500 of FIG. 5 and the first object-detection data may comprise the first object-detection data 5066 of FIG. 5. The first location may correspond to a geographic location based on GNSS coordinates of the first vehicle. In some implementations, the first object-detection data may further comprise a timestamp indicating a time at which the object of interest was detected; a first image of the object of interest; a first video snippet of the object of interest, or a first CLIP embedding of the object of interest.

The step 7060 comprises receiving, from the at least one remote computing device, second object-detection data associated with at least one second detection of the object of interest contributed by at least one second vehicle comprising at least one second location. The second object-detection data may comprise the second object-detection data 5070 of FIG. 5 and the at least one second vehicle may comprise the second vehicles 6003 of FIGS. 6a and 6b.

In some implementations, the at least one remote computing device comprises at least one remote server that integrates a plurality of the at least one second detection contributed by a plurality of the at least one second vehicle. In some implementations, the second object-detection data is retrieved from at least one historical database storing prior detections of the object of interest.

In some implementations, the at least one remote computing device comprises at least one computing device of the at least one second vehicle. In some implementations, a search request for the object of interest is transmitted to the at least one remote computing device before receiving the second object-detection data.

The step 7070 comprises integrating the first object-detection data and the second object-detection data to generate a collective search result. Integrating may be performed by the integrating module 5600 of FIG. 5 and the search result may comprise the collective search result 5074 of FIG. 5. In some implementations, the collective search result includes at least one estimated probability that the object of interest is still located at the at least one second location.

In some implementations, the first object-detection data comprises a first timestamp; the second object-detection data comprises at least one second timestamp; and integrating the first object-detection data and the second object-detection data comprises ranking the first detection and the at least one second detection based on recency. In some implementations, the at least one second detection is prioritized based on distance from the first vehicle. In some implementations, an estimated duration that the object of interest has been located at the at least one second location is determined based on the second object-detection data.

In some implementations, the process further comprises: capturing, in response to the first vehicle arriving near the at least one second location, additional image data of an additional environment near the second location; and determining whether the object of interest is still located at the at least one second location by attempting to detect the object of interest in the additional image data by the LLM and the object detector.

The step 7080 comprises, providing, to the user, an indication of the collective search result. In some implementations, the indication comprises a map of at least one of the first location or the at least one second location displayed by a GUI of a graphical display, such as the graphical display 5016 of FIG. 5. In some implementations, the indication comprises audio describing the at least one of the first location or the at least one second location by a text-to-speech system.

The above-described techniques can be implemented as a method, a system, and a non-transitory computer-readable medium, for example, as described below.

In an example implementation as a method, the method comprises: capturing image data of an environment using an image-capturing device of a first vehicle; receiving a query from a user of the first vehicle indicating an object of interest; performing, by a small language model (SLM), query understanding and object-label extraction; detecting in the image data, by a large language model (LLM) and an object detector, a first detection of the object of interest based on the object-label extraction; transmitting, to at least one remote computing device, first object-detection data associated with the first detection comprising a first location; receiving, from the at least one remote computing device, second object-detection data associated with at least one second detection of the object of interest contributed by at least one second vehicle comprising at least one second location; integrating the first object-detection data and the second object-detection data to generate a collective search result; and providing, to the user, an indication of the collective search result.

In some implementations, the first object-detection data comprises a first timestamp; and the second object-detection data comprises at least one second timestamp.

In some implementations, the first object-detection data comprises a first image; and the second object-detection data comprises at least one second image.

In some implementations, the first object-detection data comprises a first video snippet; and the second object-detection data comprises at least one second video snippet.

In some implementations, the method further comprises: determining, by contrastive language-image pretraining (CLIP), whether the first detection matches the query based on embedding similarity.

In some implementations, the method further comprises: transmitting a search request for the object of interest to the at least one remote computing device before receiving the second object-detection data.

In some implementations, the at least one remote computing device comprises at least one remote server that integrates a plurality of the at least one second detection contributed by a plurality of the at least one second vehicle.

In some implementations, the at least one remote computing device comprises at least one computing device of the at least one second vehicle.

In some implementations, the image-capturing device comprises at least one of: an optical device adapted to capture optical images; a lidar device adapted to capture lidar images; an infrared device adapted to capture infrared images; a radar device adapted to capture radar images; or a sonar device adapted to capture sonar images.

In some implementations, the query is received by a voice input captured by a microphone and processed by an automatic speech recognition (ASR) module.

In some implementations, the second object-detection data is retrieved from at least one historical database storing prior detections of the object of interest.

In some implementations, the first object-detection data comprises a first timestamp; the second object-detection data comprises at least one second timestamp; and integrating the first object-detection data and the second object-detection data comprises ranking the first detection and the at least one second detection based on recency.

In some implementations, the method further comprises: prioritizing the at least one second detection based on distance from the first vehicle.

In some implementations, the collective search result includes at least one estimated probability that the object of interest is still located at the at least one second location.

In some implementations, the method further comprises: determining, based on the second object-detection data, an estimated duration that the object of interest has been located at the at least one second location.

In some implementations, the method further comprises: capturing, in response to the first vehicle arriving near the at least one second location, additional image data of an additional environment near the second location; and determining whether the object of interest is still located at the at least one second location by attempting to detect the object of interest in the additional image data by the LLM and the object detector.

In some implementations, the method further comprises: indicating, to the user by a graphical user interface (GUI), a map-based indication of at least one of the first location or the at least one second location.

In some implementations, the method further comprises: indicating, to the user by a text-to-speech system, an audible indication of at least one of the first location or the at least one second location.

In another example implementation as a non-transitory computer-readable medium, the non-transitory computer-readable medium stores instructions operable to cause one or more processors to perform operations comprising: capturing image data of an environment using an image-capturing device of a first vehicle; receiving a query from a user of the first vehicle indicating an object of interest; performing, by a small language model (SLM), query understanding and object-label extraction; detecting in the image data, by a large language model (LLM) and an object detector, a first detection of the object of interest based on the object-label extraction; transmitting, to at least one remote computing device, first object-detection data associated with the first detection comprising a first location; receiving, from the at least one remote computing device, second object-detection data associated with at least one second detection of the object of interest contributed by at least one second vehicle comprising at least one second location; integrating the first object-detection data and the second object-detection data to generate a collective search result; and providing, to the user, an indication of the collective search result.

In another example implementation as a system, the system comprises one or more memories; and one or more processors configured to execute instructions stored in the one or more memories to: capture image data of an environment using an image-capturing device of a first vehicle; receive a query from a user of the first vehicle indicating an object of interest; perform, by a small language model (SLM), query understanding and object-label extraction; detect in the image data, by a large language model (LLM) and an object detector, a first detection of the object of interest based on the object-label extraction; transmit, to at least one remote computing device, first object-detection data associated with the first detection comprising a first location; receive, from the at least one remote computing device, second object-detection data associated with at least one second detection of the object of interest contributed by at least one second vehicle comprising at least one second location; integrate the first object-detection data and the second object-detection data to generate a collective search result; and provide, to the user, an indication of the collective search result.

As used herein, the terminology “example,” “embodiment,” “implementation,” "aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
capturing image data of an environment using an image-capturing device of a first vehicle;
receiving a query from a user of the first vehicle indicating an object of interest;
performing, by a small language model (SLM), query understanding and object-label extraction;
detecting in the image data, by a large language model (LLM) and an object detector, a first detection of the object of interest based on the object-label extraction;
transmitting, to at least one remote computing device, first object-detection data associated with the first detection comprising a first location;
receiving, from the at least one remote computing device, second object-detection data associated with at least one second detection of the object of interest contributed by at least one second vehicle comprising at least one second location;
integrating the first object-detection data and the second object-detection data to generate a collective search result; and
providing, to the user, an indication of the collective search result.

2. The method of claim 1, wherein:
the first object-detection data comprises a first timestamp; and
the second object-detection data comprises at least one second timestamp.

3. The method of claim 1, wherein:
the first object-detection data comprises a first image; and
the second object-detection data comprises at least one second image.

4. The method of claim 1, wherein:
the first object-detection data comprises a first video snippet; and
the second object-detection data comprises at least one second video snippet.

5. The method of claim 1, further comprising:
determining, by contrastive language-image pretraining (CLIP), whether the first detection matches the query based on embedding similarity.

6. The method of claim 1, further comprising:
transmitting a search request for the object of interest to the at least one remote computing device before receiving the second object-detection data.

7. The method of claim 1, wherein:
the at least one remote computing device comprises at least one remote server that integrates a plurality of the at least one second detection contributed by a plurality of the at least one second vehicle.

8. The method of claim 1, wherein:
the at least one remote computing device comprises at least one computing device of the at least one second vehicle.

9. The method of claim 1, wherein the image-capturing device comprises at least one of:
an optical device adapted to capture optical images;
a lidar device adapted to capture lidar images;
an infrared device adapted to capture infrared images;
a radar device adapted to capture radar images; or
a sonar device adapted to capture sonar images.

10. The method of claim 1, wherein:
the query is received by a voice input captured by a microphone and processed by an automatic speech recognition (ASR) module.

11. The method of claim 1, wherein:
the second object-detection data is retrieved from at least one historical database storing prior detections of the object of interest.

12. The method of claim 1, wherein:
the first object-detection data comprises a first timestamp;
the second object-detection data comprises at least one second timestamp; and
integrating the first object-detection data and the second object-detection data comprises ranking the first detection and the at least one second detection based on recency.

13. The method of claim 1, further comprising:
prioritizing the at least one second detection based on distance from the first vehicle.

14. The method of claim 1, wherein:
the collective search result includes at least one estimated probability that the object of interest is still located at the at least one second location.

15. The method of claim 1, further comprising:
determining, based on the second object-detection data, an estimated duration that the object of interest has been located at the at least one second location.

16. The method of claim 1, further comprising:
capturing, in response to the first vehicle arriving near the at least one second location, additional image data of an additional environment near the second location; and
determining whether the object of interest is still located at the at least one second location by attempting to detect the object of interest in the additional image data by the LLM and the object detector.

17. The method of claim 1, further comprising:
indicating, to the user by a graphical user interface (GUI), a map-based indication of at least one of the first location or the at least one second location.

18. The method of claim 1, further comprising:
indicating, to the user by a text-to-speech system, an audible indication of at least one of the first location or the at least one second location.

19. A non-transitory computer-readable medium storing instructions operable to cause one or more processors to perform operations comprising:
capturing image data of an environment using an image-capturing device of a first vehicle;
receiving a query from a user of the first vehicle indicating an object of interest;
performing, by a small language model (SLM), query understanding and object-label extraction;
detecting in the image data, by a large language model (LLM) and an object detector, a first detection of the object of interest based on the object-label extraction;
transmitting, to at least one remote computing device, first object-detection data associated with the first detection comprising a first location;
receiving, from the at least one remote computing device, second object-detection data associated with at least one second detection of the object of interest contributed by at least one second vehicle comprising at least one second location;
integrating the first object-detection data and the second object-detection data to generate a collective search result; and
providing, to the user, an indication of the collective search result.

20. A system, comprising:
one or more memories; and
one or more processors configured to execute instructions stored in the one or more memories to:
capture image data of an environment using an image-capturing device of a first vehicle;
receive a query from a user of the first vehicle indicating an object of interest;
perform, by a small language model (SLM), query understanding and object-label extraction;
detect in the image data, by a large language model (LLM) and an object detector, a first detection of the object of interest based on the object-label extraction;
transmit, to at least one remote computing device, first object-detection data associated with the first detection comprising a first location;
receive, from the at least one remote computing device, second object-detection data associated with at least one second detection of the object of interest contributed by at least one second vehicle comprising at least one second location;
integrate the first object-detection data and the second object-detection data to generate a collective search result; and
provide, to the user, an indication of the collective search result.
